(19) United States
(12) Patent Application Publication
(10) Pub. No.: US 2012/0109739 A1
(43) Pub. Date: May 3, 2012

(54) ARTICLE AND ADVERTISEMENT CORRELATION IN ONLINE ADVERTISING

(75) Inventor: Arpit Gupta, Banglore (IN)

(73) Assignee: Yahoo! Inc., Sunnyvale, CA (US)

(21) Appl. No.: 12/916,430

(22) Filed: Oct. 29, 2010

(51) Int. Cl. G06Q 30/00

(52) U.S. Cl. 705/14.41; 705/14.49

(57) ABSTRACT

Techniques are provided that include utilization of correlation techniques in online advertising. Methods are provided in which, for top-performing articles and advertisements, for example, correlation scores are computed, which provide a quantitative measure relating to performance. An aggregate correlation index may be computed, and individual correlation scores may be determined in relation to the correlation index. In determining positioning of scored articles and advertisements to be displayed on a Web page, preference may be given, as at least one factor in the determination, to position an article adjacent or proximate to an advertisement if they have similar correlation scores.

### BACKGROUND

Correlation techniques can be very powerful. For example, correlation analysis and techniques have been successfully and profitably used in financial and investment communities for many years.

There is a need for improved online advertising techniques.

### SUMMARY

Some embodiments of the invention provide techniques that include utilization of correlation techniques in online advertising. Methods are provided in which, for top-performing articles and advertisements, for example, correlation scores are computed, which provide a quantitative measure relating to performance. An aggregate correlation index may be computed, and individual correlation scores may be determined in relation to the correlation index. In determining positioning of scored articles and advertisements to be displayed on a Web page, preference may be given, as at least one factor in the determination, to position an article adjacent or proximate to an advertisement if they have similar correlation scores.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

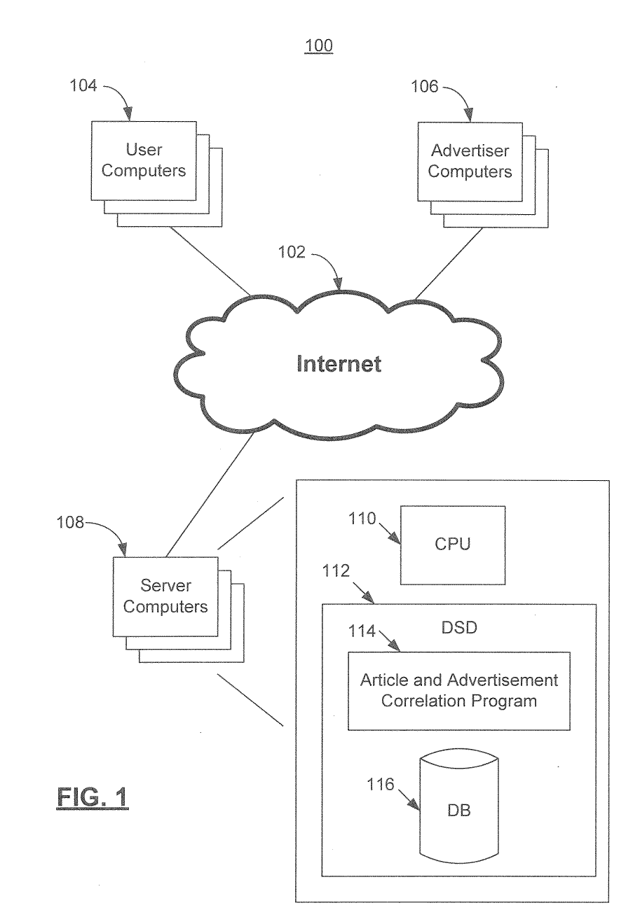

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Article and Advertisement Correlation Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

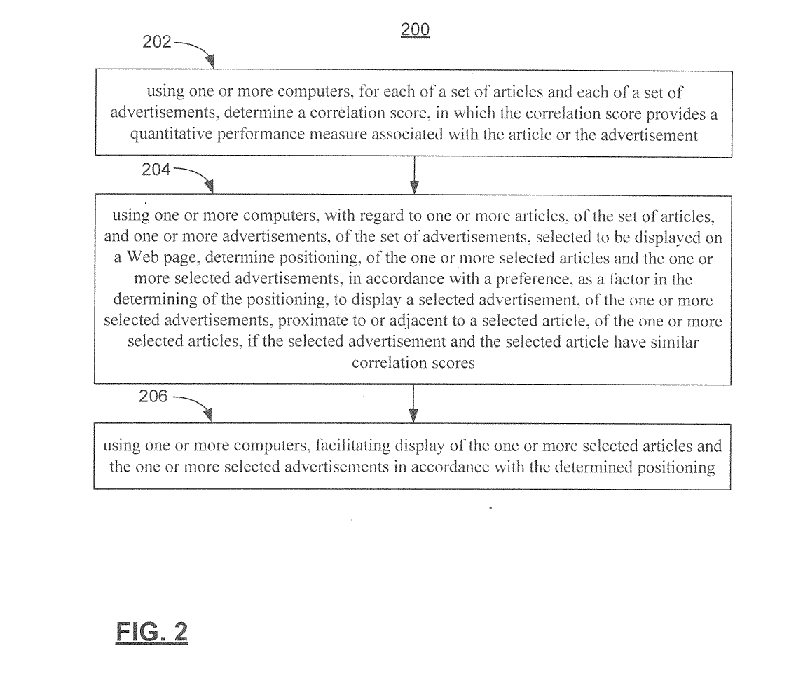

FIG. 2 is a flow diagram illustrating a method 200 according to one embodiment of the invention. At step 202, using one or more computers, for each of a set of articles and each of a set of advertisements, a correlation score is determined, in which the correlation score provides a quantitative performance measure associated with the article or the advertisement.

At step 204, using one or more computers, with regard to one or more articles, of the set of articles, and one or more advertisements, of the set of advertisements, selected to be displayed on a Web page, positioning is determined, of the one or more selected articles and the one or more selected advertisements, in accordance with a preference, as a factor in the determining of the positioning, to display a selected advertisement, of the one or more selected advertisements, proximate to or adjacent to a selected article, of the one or more selected articles, if the selected advertisement and the selected article have similar correlation scores.

At step 206, using one or more computers, display is facilitated of the one or more selected articles and the one or more selected advertisements in accordance with the determined positioning.

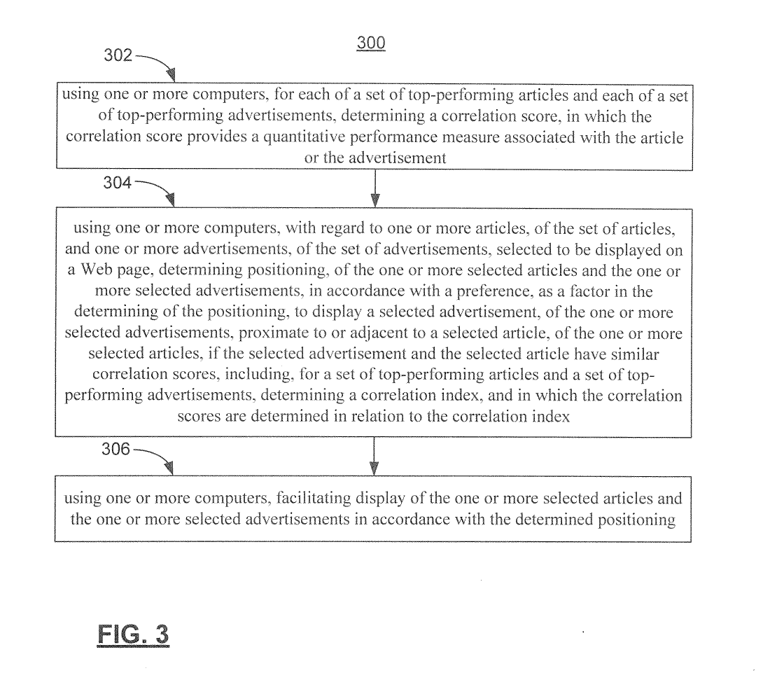

FIG. 3 is a flow diagram illustrating a method 300 according to one embodiment of the invention. Step 302 is similar to step 202 as depicted in FIG. 2.

At step 302, using one or more computers, for each of a set of top-performing articles and each of a set of top-performing advertisements, a correlation score is determined, in which the correlation score provides a quantitative performance measure associated with the article or the advertisement.

At step 304, using one or more computers, with regard to one or more articles, of the set of articles, and one or more advertisements, of the set of advertisements, selected to be displayed on a Web page, positioning is determined, of the one or more selected articles and the one or more selected advertisements, in accordance with a preference, as a factor in the determining of the positioning, to display a selected advertisement, of the one or more selected advertisements, proximate to or adjacent to a selected article, of the one or more selected articles, if the selected advertisement and the selected article have similar correlation scores. The method 200 includes, for a set of top-performing articles and a set of top-performing advertisements, determining a correlation index, and in which the correlation scores are determined in relation to the correlation index.

It is to be understood that determining positioning of an article and an advertisement can occur, for example, either by determining to position an article such that it is adjacent or proximate to an article, or vice-versa, and may include but does not require both.

At step 306, using one or more computers, display is facilitated of the one or more selected articles and the one or more selected advertisements in accordance with the determined positioning.

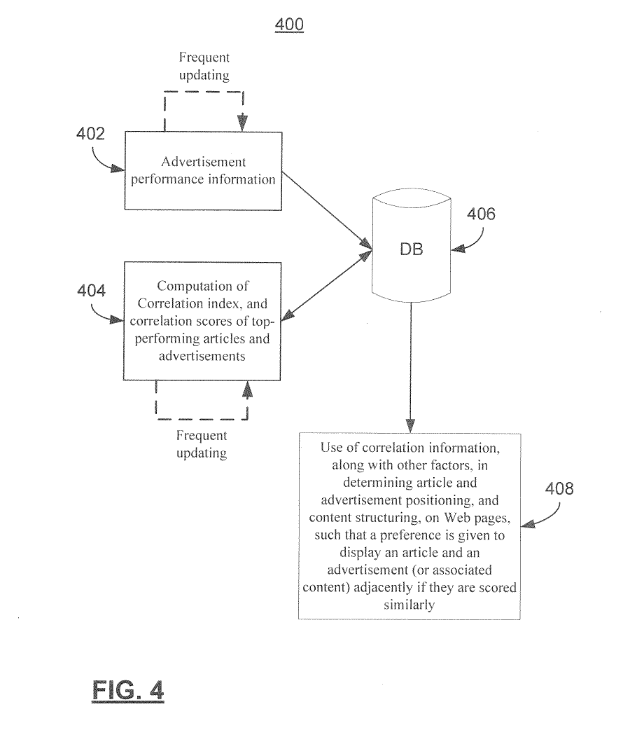

FIG. 4 is a block diagram 400 illustrating one embodiment of the invention. As depicted, information, including frequently updated advertisement performance information 402, is stored in one or more databases 406.

Information including advertisement performance information, and in some embodiments, particularly advertisement performance information relating to top-performing articles and advertisements, is used in computation of a correlation index as well as correlation scores for particular top-performing articles and advertisements 404, which information is also frequently updated.

Block 408 represents use of correlation information, along with other factors, in determining article and advertisement positioning, and content structuring, on Web pages, such that a preference is given to display an article and an advertisement (or associated content) adjacently if they are scored similarly. Of course, many other factors may also be taken into account, including various targeting criteria.

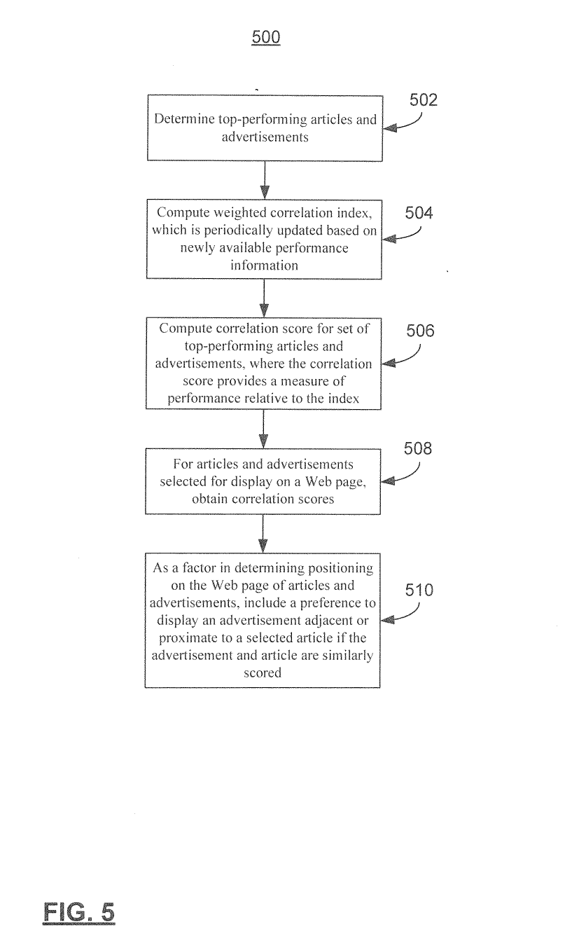

FIG. 5 is a flow diagram illustrating a method 500 according to one embodiment of the invention. At step 502, top-performing articles and advertisements are determined or identified.

At step 504, a weighted correlation index is computed, which is periodically updated based on newly available performance information.

At step 506, correlation scores are computed for set of top-performing articles and advertisements, where a correlation score provides a measure of performance of the article or advertisement relative to the correlation index.

At step 508, for articles and advertisements selected for display on a Web page, correlation scores are obtained.

At step 510, as a factor in determining positioning on the Web page of articles and advertisements, a preference is included to display an advertisement adjacent or proximate to a selected article if the advertisement and article are similarly scored.

Some embodiments of the invention include a recognition that displaying similarly scored articles and advertisements adjacent or proximate to each other can lead to overall enhanced performance, such as may be associated with the advertisements, articles, or both.

Some embodiments of the invention recognize that a lot of correlation analysis is done in the financial and investment communities, such as for stock trading, M&A etc. Correlation can be a very powerful technique. Correlation can be used, for example, to see or predict which articles and advertisements will lead to enhanced performance if shown adjacently or close to each other, for example, and that can be used in determining aspects of what to show on page. For example, correlation scores can be calculated and compared between the most clicked and read advertisements and articles, and a preference can be demonstrated to show those adjacent to each other. This can, for example, improve relevance and click through rate.

Some embodiments of the invention include use of a correlation model. In some embodiments, the base index is computed, such as based on the top performing articles and advertisements, and the “weighted mean” is computed. This weight or weighting may include consideration or adjustment in view of, for example, demographics, geographies and other targeting metrics. Once the index is determined, the performance of advertisements and articles can be measured against the index. The articles and advertisements that show positive correlation (where positive correlation means having similar scores) may result in, for example, co-locating them on the same page. This may increase the propensity for a user to click, read the complete content, etc. In some embodiments, the positioning of the articles can also be tailored based on other factors affecting what should be co-located, which advertisements go well with what articles in various ways, etc. In some embodiments, the index can be regularly updated as the performance of advertisements and articles keeps evolving over time. The actual placement of the advertisements and the articles may also be based on correlation. The items that show more correlation may be co-located or be more likely to be co-located, etc.

In some embodiments, co-location of correlated articles and advertisements can improve the click rates, engagement, or other performance measures. Some embodiments of the invention provide a statistical model on top of normal targeting, which may, for example, increase advertisement performance, user spend times on a Web site or associated portal, etc.

In some embodiments, correlation scores are calculated for the top performing advertisement and articles. Scores can be relative to an aggregate correlation index. The correlation between an article and an advertisement can mean the similarity of scores. In some embodiments, correlation between all the high performing advertisements and articles can be determined, to facilitate determinations regarding co-location. For example, highly correlated articles and advertisements may be co-located, while poorly correlated ones (such as with very different scores) may not be. In some embodiments, it is attempted to co-locate as many items as possible while also incorporating factors relating to other targeting criteria or dimensions, such as vertical, geography, time, gender, etc. Advertisements and articles shown on a Web page may undergo this analysis to help provide, for example, more engaging content for users, in addition to existing targeting and other analyses. Furthermore, in some embodiments, another aspect is to co-locate the highest correlated items and position them at relevant or more places on the page. As such, prioritization or specialized treatment may be given to articles and advertisements with high scores generally, for example.

In some embodiments, top performing advertisements and articles (which can be determined in various ways and with various standards) will be applied weights, and an aggregated correlation index will be computed. In some embodiments, this index will get updated whenever new performance statistics get generated for advertisements and articles. Additional weights may be applied on specific targeting dimensions to remove any noise or bias, to focus just on the performance of the items.

In some embodiments, an item correlation calculator feature may be utilized, using which all the top performing items may be correlated against the index to determine scores associated with their performance (which can include predicted performance).

In some embodiments, at the serving system, when the advertisements and articles are being chosen, they will also be subjected to the calculator and selection or limitation on displayed advertisements or articles may be made to prioritize highly correlated pairings, or high scoring and highly correlated pairings, for example.

In some embodiments, the placement of advertisements and/or articles on a Web page or portal again include use of the correlation between the items on the page, where items showing a high degree of correlation will be preferred for co-location. In some embodiments, the structuring of the content on the page will also be determined based at least in part on the principle of correlation, such as by co-locating content of similarly scored items.

In some embodiments, co-location (which can include adjacent or proximate placement) may lead to increased user engagement, such as be helping provide relevant or engaging content together on the same page. Higher click through rate on articles and advertisements may occur, with users staying longer and engaging more on the Web page, for example.

In some embodiments, the index is updated whenever the performance statistics for articles and advertisements change. In some embodiments, this can require very quick or frequent updates to keep the index up-to-date.

In some embodiments, for a particular serving context, such as may be associated with a particular geographic region, etc., all the relevant articles and advertisement undergo calculator analysis to determine correlation scores. Items with highest correlations, or highest scores generally plus highest correlations, are chosen for display. Of course, any of various particular techniques or algorithms may be utilized in this regard. In some embodiments, Structuring of the selected items is also done, such as based at least in part on descending order of correlation, for example. In some embodiments, relevant articles and advertisements are shown at determined specific positions and may be shown adjacent to correlated items.

As mentioned above, in some embodiments, the correlation index is frequently updated as new or different performance information becomes available. In some embodiments, the following steps are employed. All the top performing “n” (where “n” is a number that could be determined in various ways) advertisements and articles are aggregated. Appropriate weights are then applied on each of them. A weighted mean then is then computed, which, in some embodiments, is the index. All of the foregoing steps may be repeated whenever performance statistics are updated.

While the invention is described with reference to the above drawings, the drawings are intended to be illustrative, and the invention contemplates other embodiments within the spirit of the invention.

1. A method comprising:
using one or more computers, for each of a set of articles and each of a set of advertisements, determining a correlation score, wherein the correlation score provides a quantitative performance measure associated with the article or the advertisement;
using one or more computers, with regard to one or more articles, of the set of articles, and one or more advertisements, of the set of advertisements, selected to be displayed on a Web page, determining positioning, of the one or more selected articles and the one or more selected advertisements, in accordance with a preference, as a factor in the determining of the positioning, to display a selected advertisement, of the one or more selected advertisements, proximate to or adjacent to a selected article, of the one or more selected articles, if the selected advertisement and the selected article have similar correlation scores; and
using one or more computers, facilitating display of the one or more selected articles and the one or more selected advertisements in accordance with the determined positioning.

2. The method of claim 1, wherein correlation analysis is further utilized in selection of articles and advertisements to be displayed on the Web page.

3. The method of claim 1, wherein the determining of the positioning is based in part on other factors including targeting factors.

4. The method of claim 1, comprising, for a set of top-performing articles and a set of top-performing advertisements, determining a correlation index, and wherein correlation scores are determined in relation to the correlation index.

5. The method of claim 1, comprising weighting of correlation scores at least in part to remove effects of statistical noise or bias.

6. The method of claim 1, comprising structuring of content of articles and advertisements taking into account similarity of correlation scores between articles and advertisements.

7. The method of claim 1, comprising serving and display of the one or more selected articles and the one or more selected advertisements in accordance with the determined positioning.

8. The method of claim 1, wherein determining a correlation score comprises determining a measure of a level of online performance.

9. The method of claim 1, wherein determining a correlation score comprises determining a measure of a level of predicted online performance.

10. The method of claim 1, comprising determining positioning with a preference to show a selected article and a selected advertisement, with similar correlation scores, adjacently.

11. The method of claim 1, comprising determining positioning such that a preference is given to displaying pairs of articles and advertisements with very similar correlations scores in prominent positions on the Web page.

12. The method of claim 1, comprising determining positioning such that a preference is given to displaying pairs of articles and advertisements with high and very similar correlation scores in prominent positions on the Web page.

13. The method of claim 1, comprising repeatedly updating the correlation index as new performance information becomes available.

14. A system comprising:
one or more server computers coupled to a network; and
one or more databases coupled to the one or more server computers;
wherein the one or more server computers are for:
for each of a set of articles and each of a set of advertisements, determining a correlation score, wherein the correlation score provides a quantitative performance measure associated with the article or the advertisement;
with regard to one or more articles, of the set of articles, and one or more advertisements, of the set of advertisements, selected to be displayed on a Web page, determining positioning, of the one or more selected articles and the one or more selected advertisements, in accordance with a preference, as a factor in the determining of the positioning, to display a selected advertisement, of the one or more selected advertisements, proximate to or adjacent to a selected article, of the one or more selected articles, if the selected advertisement and the selected article have similar correlation scores; and
facilitating display of the one or more selected articles and the one or more selected advertisements in accordance with the determined positioning.

15. The system of claim 14, wherein at least one of the one or more server computers are coupled to the Internet.

16. The system of claim 14, comprising display of the one or more selected articles and the one or more selected advertisements in accordance with the determined positioning.

17. The system of claim 14, comprising serving and display of the one or more selected articles and the one or more selected advertisements in accordance with the determined positioning.

18. The system of claim 1, wherein determining a correlation score comprises determining a measure of a level of online performance.

19. The system of claim 14, comprising, for a set of top-performing articles and a set of top-performing advertisements, determining a correlation index, and wherein correlation scores are determined in relation to the correlation index.

20. A computer readable medium or media containing instructions for executing a method comprising:
using one or more computers, for each of a set of top-performing articles and each of a set of top-performing advertisements, determining a correlation score, wherein the correlation score provides a quantitative performance measure associated with the article or the advertisement;
using one or more computers, with regard to one or more articles, of the set of articles, and one or more advertisements, of the set of advertisements, selected to be displayed on a Web page, determining positioning, of the one or more selected articles and the one or more selected advertisements, in accordance with a preference, as a factor in the determining of the positioning, to display a selected advertisement, of the one or more selected advertisements, adjacent to a selected article, of the one or more selected articles, if the selected advertisement and the selected article have similar correlation scores,
comprising, for a set of top-performing articles and a set of top-performing advertisements, determining a correlation index, and wherein correlation scores are determined in relation to the correlation index; and
using one or more computers, causing display of the one or more selected articles and the one or more selected advertisements in accordance with the determined positioning.
